(19) United States
(12) Patent Application Publication
(10) Pub. No.: US 2015/0216347 A1
(43) Pub. Date: Aug. 6, 2015

(54) MODULAR TEMPERATURE CONTROL SYSTEM

(71) Applicant: Grant Instruments (Cambridge) Limited, Royston Hertfordshire (GB)

(72) Inventors: Justin Philip Pisani, Cambridge Cambridgeshire (GB); Daniel Lawrence Easton, Cambridge Cambridgeshire (GB)

(21) Appl. No.: 14/425,998

(22) PCT Filed: Sep. 5, 2013
(86) PCT No.: PCT/EP2013/068388

§ 371 Date: Mar. 4, 2015

(30) Foreign Application Priority Data
Sep. 5, 2012 (GB) 1215875.4

(51) Int. Cl. A47J 27/62

(52) U.S. Cl. CPC A47J 27/62

(57) ABSTRACT

A modular temperature control system 10 that controls the temperature of at least one item 18 in the form of a scientific sample or food sample to be cooked sous-vide. The modular temperature control system 10 comprises a plurality of modules including a location module 16 and a temperature control module 12. The location module is arranged to locate the at least one item 18. The location module comprises a location module connector for connecting to a control module connector of the temperature control module. The temperature control module comprises a controller to control temperature of the at least one item. The temperature control module comprises a control module connector for connecting to the location module connector. The modular temperature control system is configured such that, in use, the control module connector is connected to the location module connector; and the controller of the temperature control module 12 controls the temperature of the at least one item 18 via the connected control module connector and container module connector.

### FIELD OF THE INVENTION

The present invention relates to a modular temperature control system, and a temperature control module and a location module for the modular temperature control system. The modular temperature control system, temperature control module and location module and particularly for, but not limited to, use in the scientific instruments field and the sous vide cooking field.

### BACKGROUND OF THE INVENTION

Scientific sample preparation and the facilitation of chemical reactions in scientific laboratories, clinics and hospitals routinely involves thermal preparation devices. Such devices include water baths, and dry block heaters and coolers.

Such devices provide a controlled and stable environment in which a sample is immersed in an appropriate carrier vessel such as an eppendorf-type tube, test tube or flask. The method of applying the heat to the carrier vessel is fixed by the type of device sample interface provided in the specific unit in use. Such interfaces include a water or fluid bath (for example, Grant Instruments (of Cambridge, UK) JB Aqua) or a thermally conductive solid block (for example, Grant Instruments QBD Series) amongst others.

Water baths have been used in these environments since the 1950s. A water bath maintains a volume of water at a set temperature and samples held in glassware or other vessels are immersed in the water. The water combines good heat capacity and high thermal conductivity (high contact area with sample vessels) ensuring that the sample is held at the required temperature. Temperature control using water is limited to a range between ˜0° C. and 100° C. being the temperature at which water is in a liquid state at normal room pressure.

Water baths are usually constructed either from a stainless steel tank with a mat heater attached to the base or a plastic tank with an immersed element heater. This tank/heater assembly is contained within an outer case which also includes integrally the control mechanism and user interface (UI) for controlling the device, such as setting a target temperature and maintaining the device at the target temperature. Initially, the temperature control was via a mechanical thermostat but more recently the technology has shifted towards electronic solutions.

Dry block heaters (and coolers) provide a dry method of temperature control of samples between ambient temperature and up to 400° C. Typically, aluminium blocks are used with one or more recesses machined of suitable size and depth to fit sample vessels matched to the one or more recesses. In a similar way to water baths, dry block heaters have integral control mechanisms and UIs for controlling the device, such as setting a target temperature and maintaining the device at the target temperature.

### BRIEF SUMMARY OF THE INVENTION

The inventors of the arrangement described below are the first to appreciate that a modular temperature control system for controlling temperature of at least one item, particularly in the scientific instruments field and the sous vide cooking field, would be beneficial where the modular temperature control system comprises a plurality of modules including a temperature control module and a location module and where different location modules such as water baths, hot plates or dry blocks may be used with the same temperature control module.

Examples of the modular temperature control system or modular thermostatic controller utilise a universal control module that allows convenient interchange between receptacles containing a heat transfer medium, for example, liquid or sand; chambers containing fluids; or receptacles holding metal blocks or beads. Examples of the control module enable the temperature of the fluid or solid within the attached receptacle to be controlled by interfacing to the heater mechanism and the temperature measurement probe of the receptacle via a connector. A user with a single control module may interchange receptacles or container modules to create a water bath, an incubator oven or a dry block heater to meet their specific requirements. The control module may be powered from a mains supply. The control module may contain control electronics, a user interface and a connector to interface to the different receptacles. The receptacles may hold the working fluid or solid and may contain an appropriately configured heater, temperature measurement probe and a mating connector to the control module. The system may be used for temperature control during sample preparation or sous vide cooking, for example.

A waterbath may be provided where the vessel containing the water may be connected and separated from the control module. A block heater may be provided where blocks of the block heater may be connected and separated from the control module. An incubator may be provided where the incubator chamber may be connected and separated from the control module. The control module and, in particular, the same control module may control temperature in a dry block or a wet bath or water bath system.

The integrated nature of the control and UI of the prior art water bath and dry block heater described in the background of the invention section above means that a user must have separate water baths or dry block heaters including control, UI and sample holder for every different volume of sample holder as well as thermal media type. These are specific to the device purchased and may necessitate several devices being purchased, including associated expense, to meet all laboratory requirements. Indeed, all devices may not be readily available and, as a result, a water bath or dry block heater bigger than required is often used wasting energy and using extra laboratory surface space, which is at a premium. Furthermore, in the arrangement described herein, as the same UI of the temperature control module is used independent of container module it is controlling, there is a common interface for all products or container modules. Thus, the user only needs to be familiar with a single UI.

The arrangement described below provides a flexible approach to temperature control. It provides for low energy use as arrangements may be readily configured to only heat the minimum required amount of water or blocks or at least reduced amounts compared to the prior art.

The arrangement described below provides for, at the point of experiment, the device sample interface or container module to be selected to be the most appropriate for the task by the user on a single device. In order to achieve the precision and thermal stability, the device and, in particular the temperature control module, modifies the thermal control characteristics used to heat or cool the sample to take account of the variation of thermal mass of the device sample interface.

The arrangement described below also has advantages regarding transportation. When being transported from manufacturing facility to customer, a considerable volume of a prior art water bath, for example, described in the background of the invention section is air. As transportation costs are based on total volume of product, wasteful transportation costs result. By having a modular temperature control system, such as that described below, a temperature control module, typically including specialist electronics that may only typically be manufactured in very particular locations, may be transported separately to the container module, that may typically be manufactured in more locations and could thus, typically, be transported to a customer over a shorter distance than the temperature control module (and the prior art integral arrangement). In addition to reduced transportation costs, this arrangement reducing transportation distances provides substantial environmental benefits.

The invention in its various aspects is defined in the independent claims below to which reference should now be made. Advantageous features are set forth in the dependent claims.

Arrangements are described in more detail below and take the form of a modular temperature control system that controls the temperature of at least one item in the form of a scientific sample or food sample to be cooked sous-vide. The modular temperature control system comprises a plurality of modules including a location module and a temperature control module. The location module is arranged to locate the at least one item. The location module comprises a location module connector for connecting to a control module connector of the temperature control module. The temperature control module comprises a controller to control temperature of the at least one item. The temperature control module comprises a control module connector for connecting to the location module connector. The modular temperature control system is configured such that, in use, the control module connector is connected to the location module connector; and the controller of the temperature control module controls the temperature of the at least one item via the connected control module connector and container module connector.

In an aspect of the present invention, there is provided a modular temperature control system for controlling temperature of at least one item in the form of a scientific sample or food sample to be cooked sous-vide, the modular temperature control system comprising a plurality of modules including a location module and a temperature control module: the location module being arranged to locate at least one item in the form of a scientific sample or food sample to be cooked sous vide, and the location module comprising a location module connector for connecting to a control module connector of the temperature control module; the temperature control module comprising a controller to control temperature of the at least one item and a control module connector for connecting to the location module connector; the modular temperature control system being configured such that, in use, the control module connector is connected to the location module connector; and the controller of the temperature control module controls the temperature of the at least one item via the connected control module connector and location module connector.

The modular temperature control system may further comprise a temperature measurement probe for measuring the temperature of the at least one item. The location module may comprise the temperature measurement probe. The temperature measurement probe may be electrically connected to the location module connector.

The modular temperature control system may further comprise a temperature changer, such as a heater or a cooler or the like. The location module may comprise the temperature changer.

The temperature control module may control temperature of the at least one item of below ±0.5° C. of a target temperature. The temperature control module may control temperature of the at least one item of below ±0.3° C. of a target temperature.

The location module may comprise a water bath or a dry block heater or a dry block cooler or an incubator or a hot plate.

The control module connector and location module connector may be configured to be electrically connected together.

The control module connector and location module connector may be configured to be mechanically connected together. The control module connector and the location module connector may be configured to be locked together. The control module connector and the location module connector may be configured to be wirelessly connected together.

The temperature control module may comprise a magnetic stirrer.

The controller may comprise a microprocessor. The microprocessor may control temperature of the at least one item as a proportional-integral-derivative (PID) controller.

The temperature control module may comprise a user interface. The temperature control module may comprise a mains electricity supply and may provide electrical power to the location module through the connected control module connector and location module connector.

In another aspect of the present invention, there is provided a temperature control module for a modular temperature control system for controlling temperature of at least one item in the form of a scientific sample or food sample to be cooked sous-vide, the modular temperature control system comprising a plurality of modules including the temperature control module and a location module arranged to locate the at least one item: the temperature control module comprising a controller to control temperature of at least one item and a control module connector for connecting to a location module connector of a location module; and the temperature control module being configured such that, in use, the control module connector is connected to the location module connector of the location module; and the controller of the temperature control module controls the temperature of the at least one item via the connected control module connector and location module connector.

The temperature control module may control temperature of the at least one item of below ±0.5° C. of a target temperature. The temperature control module may control temperature of the at least one item of below ±0.3° C. of a target temperature.

The location module may comprise a water bath or a dry block heater or a dry block cooler or an incubator or a hot plate.

The control module connector may be configured to be electrically connected to the location module connector. The control module connector may be configured to be mechanically connected to the location module connector. The control module connector may be configured to lock to the location module connector. The control module connector may be configured to be wirelessly connected to the location module connector.

The temperature control module may comprise a magnetic stirrer. The controller may comprise a microprocessor. The microprocessor may control temperature of the at least one item as a proportional-integral-derivative (PID) controller.

The temperature control module may comprise a user interface.

The temperature control module may comprise a mains electricity supply and provides electrical power to the location module through the control module connector.

In another aspect of the present invention, there is provided a location module for a modular temperature control system for controlling temperature of at least one item in the form of a scientific sample or food sample to be cooked sous-vide, the modular temperature control system comprising a plurality of modules including a temperature control module and the location module: the location module being arranged to locate at least one item in the form of a scientific sample or food sample to be cooked sous-vide, and the location module comprising a location module connector for connecting to a control module connector of a temperature control module; the location module being configured such that, in use, the control module connector is connected to the location module connector; and a controller of the control module controls the temperature of the at least one item via the connected control module connector and location module connector.

The location module may comprise a temperature measurement probe. The temperature measurement probe may be electrically connected to the location module connector.

The location module may comprise a temperature changer, such as a heater or a cooler or the like.

The location module may comprise a water bath or a dry block heater or a dry block cooler or an incubator or a hot plate.

The location module connector may be configured to be electrically connected to the control module connector. The location module connector may be configured to be mechanically connected to the control module connector. The location module connector may be configured to be locked to the control module connector. The location module connector may be configured to be wirelessly connected to the control module connector.

In a yet further aspect of the present invention, there is provided a method of assembling a modular temperature control system for controlling temperature of at least one item in the form of a scientific sample or food sample to be cooked sous-vide, the modular temperature control system comprising a plurality of modules including a location module and a temperature control module: the location module being arranged to locate at least one item in the form of a scientific sample or food sample to be cooked sous-vide, and the location module comprising a location module connector for connecting to a control module connector of the temperature control module; the temperature control module comprising a controller to control temperature of the at least one item and a control module connector for connecting to the location module connector; the modular temperature control system being assembled by connecting the location module connector to the control module connector.

The connecting may be by placing the location module on the temperature control module, sliding the location module on to and/or to engage with the temperature control module, or lifting the location module to engage with the temperature control module. For example, the connection or attachment of the control module to the location module may be by slotting in the location module sideways or upwards via a bayonet lock or the like.

In a yet further aspect of the present invention, there is provided a kit of modules which, when assembled, form a temperature control system for controlling temperature of at least one item in the form of a scientific sample or food sample to be cooked sous-vide, the modules including a location module and a temperature control module: the location module being arranged to locate at least one item in the form of a scientific sample or food sample to be cooked sous-vide, and the location module comprising a location module connector for connecting to a control module connector of the temperature control module; the temperature control module comprising a controller to control temperature of the at least one item and a control module connector for connecting to the location module connector; the modular temperature control system being configured such that when assembled and, in use, the control module connector is connected to the location module connector; and the controller of the temperature control module controls the temperature of the at least one item via the connected control module connector and location module connector.

The kit of modules may comprise a plurality of different location modules. The different location modules may be of different sizes or are for containing different heat transfer media.

The different location modules may comprise at least two of: a water bath, a hot plate and a solid block.

In a further aspect of the present invention, there is provided a modular temperature control system for controlling temperature of at least one item, the modular temperature control system comprising a plurality of modules including a location module and a temperature control module: the location module being arranged to locate at least one item, and the location module comprising a location module connector for connecting to a control module connector of the temperature control module; the temperature control module comprising a controller to control temperature of the at least one item at a substantially steady state below ±0.5° C. of a target temperature and a control module connector for connecting to the location module connector; the modular temperature control system being configured such that, in use, the control module connector is connected to the location module connector; and the controller of the temperature control module controls the temperature of the at least one item via the connected control module connector and location module connector at a substantially steady state below ±0.5° C. of a target temperature.

In a further aspect of the present invention, there is provided a temperature control module for a modular temperature control system for controlling temperature of at least one item, the modular temperature control system comprising a plurality of modules including the temperature control module and a location module arranged to locate the at least one item: the temperature control module comprising a controller to control temperature of at least one item at a substantially steady state below ±0.5° C. of a target temperature and a control module connector for connecting to a location module connector of a location module; and the temperature control module being configured such that, in use, the control module connector is connected to the location module connector of the location module; and the controller of the temperature control module controls the temperature of the at least one item via the connected control module connector and location module connector at a substantially steady state below ±0.5° C. of a target temperature.

In a further aspect of the present invention, there is provided a method of assembling a modular temperature control system for controlling temperature of at least one item, the modular temperature control system comprising a plurality of modules including a location module and a temperature control module: the location module being arranged to locate at least one item, and the location module comprising a location module connector for connecting to a control module connector of the temperature control module; the temperature control module comprising a controller to control temperature of the at least one item at a substantially steady state below ±0.5° C. of a target temperature and a control module connector for connecting to the location module connector; the modular temperature control system being assembled by connecting the location module connector to the control module connector.

In a further aspect of the present invention, there is provided a kit of modules which, when assembled, form a temperature control system for controlling temperature of at least one, the modules including a location module and a temperature control module: the location module being arranged to locate at least one item, and the location module comprising a location module connector for connecting to a control module connector of the temperature control module; the temperature control module comprising a controller to control temperature of the at least one item at a substantially steady state below ±0.5° C. of a target temperature and a control module connector for connecting to the location module connector; the modular temperature control system being configured such that when assembled and, in use, the control module connector is connected to the location module connector; and the controller of the temperature control module controls the temperature of the at least one item at a substantially steady state below ±0.5° C. of a target temperature via the connected control module connector and location module connector.

### BRIEF DESCRIPTION OF THE DRAWINGS

The invention will be described in more detail, by way of example, with reference to the accompanying drawings, in which:

FIG. 1 is a schematic view of a modular temperature control system embodying an aspect of the present invention;

FIG. 2 is a perspective view of a temperature control module of a modular temperature control system embodying an aspect of the present invention; and

FIGS. 3, 4 and 5 are each a perspective view of different modular temperature control systems each embodying an aspect of the present invention including the temperature control module of FIG. 2 and each with a different container modular embodying an aspect of the present invention.

### DETAILED DESCRIPTION OF THE INVENTION

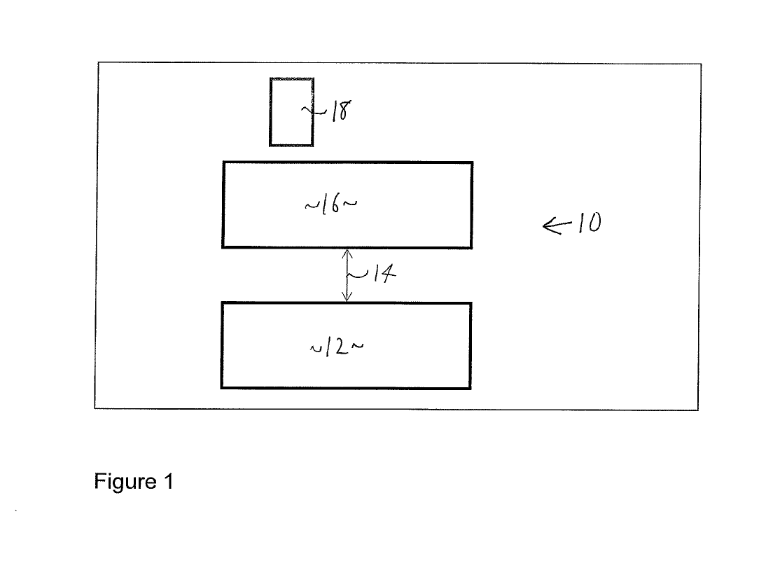

A general example modular temperature control system will now be described with reference to FIG. 1. The modular temperature control system of FIG. 1 is for controlling temperature of at least one item or sample, such as a scientific test sample or a food sample to be cooked sous-vide.

Broadly, the modular temperature control system 10 comprises a plurality of modules, in this example, two different modules, in the form of a temperature control module 12 and a location module 16 that are described in detail further below. The location module, may be, for example a container module that contains a sample or samples in a heat transfer medium (such as a water bath or solid block) or a hot plate (a flat temperature controlled plate). The location module rests on and is detachably connected to the separate temperature control module that controls the temperature of the sample or samples it. The interface 14 between the temperature control module 12 and location module 16 is exaggerated in the schematic of FIG. 1 to emphasise that the modules are separate devices and may be readily attached and detached from one another; they are configured to detach from one another.

The temperature control module or main controller unit 12 contains or includes an energy input (not shown, but such as a battery or mains electricity supply), a thermal controller (not shown) and an interface 14 with the location module 16. The interface enables a thermal control measurement function and controlled energy output function to be achieved across it.

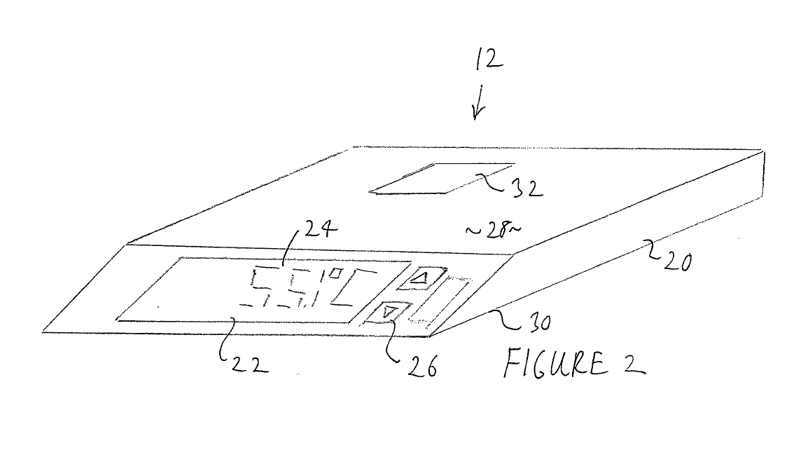

An example temperature control module 12 of the modular temperature control system is shown in more detail in FIG. 2. It includes a casing or housing 20, which in this example, in plan view, has a generally rectangular shape. One end of the housing includes a user interface (UI) 22 for entering and displaying information relevant to the temperature control module. The UI includes a display 24 such as a liquid crystal display (LCD) or light emitting diode (LED) display that displays information relevant to the temperature control module, such as target temperature and current actual temperature. The UI also includes a plurality of control input buttons 26 for entering information relevant to the temperature control module, such as the target temperature. In this example, the control input buttons are mechanical switches. However, other switch arrangements are possible including non contact, touch based and remote wireless control. In this example, the UI slopes downwardly and outwardly to from a ramp from the upper surface 28 of the temperature control module to the base or bottom 30 of the module that rests on a surface such as a laboratory bench. As a result, the display is more user-friendly.

The temperature control module 12 also includes a control module connector 32 for detachably connecting to a location module connector of the location module (not shown in FIG. 2). The control module connector provides electrical power from the temperature control module to the location module and also for receiving electrical signals from a temperature measurement probe of a location module.

Within the casing or housing of the temperature control module is a controller, such as a processor or microprocessor or thermostat (not shown) to control the temperature of at least one item on or in the location module. The processor controls the electrical power delivered from the control module connector to a temperature changer, such as a heating element or mat, of the location module typically at a substantially steady state within a range of a target temperature (for example below ±0.5° C. of a target temperature or below ±0.3° C. of a target temperature or between ±(0.5 and 0.01°) C. of a target temperature or between ±(0.3 and 0.01°) C. of a target temperature). This is sufficient temperature stability for scientific samples or sous vide cooking. The processor also receives electrical signals from a temperature measurement probe of a location module from the control module connector. The processor processes the electrical signals to determine the electrical power to deliver to the control module connector and controls the electrical power accordingly. In this example, the controller or processor is in the form of a PID (proportional-integral-derivative) controller and the control module controls the heating element of the location module accordingly. This provides for stable temperature control, as mentioned above, of, for example, below ±0.5° C. and preferably below ±0.3° C. or ±0.2° C. of a target temperature. In this example, the energy or thermal controller or processor includes a simple microcontroller device (for example, Analog Devices—ADuC847BSZ62-5) which takes a measure of the thermal status (received from the location module) via a thermal measurement function and uses this input to compute the power which should be applied to the energy output of the connector and supplied to the location module. The energy output may be controlled using a variety of means including methods such as a mechanical electrical switching device or a solid state switch using TRIAC semiconductors (for example, ST Microelectronics—BTA25-600BW).

The energy input to the temperature control module is provided from an electrical supply for example a battery or mains line electricity.

The temperature control module 12 is a sealed unit. Thus, it is waterproof. Liquid, such as water, cannot penetrate it.

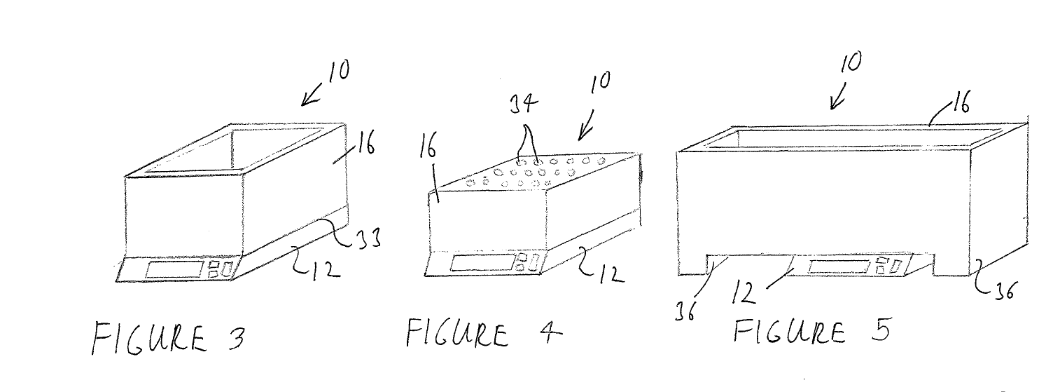

FIG. 3 illustrates the complete modular temperature control system 10. It includes the temperature control device 12 of FIG. 2 and a location module in the form of a container module or water bath module 16 for containing a heat transfer medium, such as water, and the at least one item, such as a scientific sample in a vessel, such as a test tube in the heat transfer medium or a sous vide food sample. The location module has a location module connector (not shown) for connecting to the control module connector (not shown in FIG. 3) that together form an interface (interface 14 of FIG. 1). It also has a temperature changer, in this example in the form of a heating element or mat (although this could be a cooling or chilling element), and a temperature measurement probe.

The modular temperature control system 10 is configured such that, in use, the control module connector is connected to the location module connector. The connection forms a mechanical and an electrical connection between the control module and the container module (alternatively or additionally, the connection may be a wireless connection). The processor or controller of the control module controls the temperature of the at least one item via the connected control module connector and location module connector by sending electrical signals to the temperature changer and receiving electrical signals from the temperature measurement probe via the connected control module connector and location module connector.

Significantly, in the modular temperature control system, the device sample interface or location module 16 may comprise any suitable media vessel type, such as a fluid tank or a solid block, and these may be of different sizes, shapes and volumes and may be connected to and controlled by the same temperature control module 12. This is achieved by placing the desired container or location module (at least in part) on to the temperature control module such that the desired container or location module connector and control module connector are connected (both electrically and mechanically). If it is then desired to change location module, one location module is lifted or raised from the temperature control module and the connection between the location module connector and control module connector is disconnected or broken (both electrically and mechanically). The next desired different location module is placed on the same temperature control module as described above. This is illustrated in FIGS. 3, 4 and 5. In FIG. 3, a location model in the form of a container module 16 in the form of a water bath (in this example, of 5 litre capacity) is shown on the temperature control module 12. The base of the water bath 33 of FIG. 3 has the same periphery as the upper surface of the temperature control module. In FIG. 4, a container module 16 in the form of a solid block including holes or recesses 34 for samples is shown on the same temperature control module 12. The base of the solid block is the same size as that of the water block of FIG. 3. In FIG. 5, a container module 16 in the form of a water bath, but of a larger volume (18 litre capacity) and base size to that of FIG. 3 is shown on the same temperature control module 12 as that of FIGS. 3 and 4. As the rectangular base of the water bath of FIG. 5 projects beyond the upper surface of the temperature control module it includes legs along two sides to support the water bath on the same flat surface as the temperature control device. As illustrated, several types and sizes of device sample interface or container module may be produced. For example, water bath capacities of 5, 12 and 18 litres or, generally, 1 to 30 litres may be provided. For example, dry or wet heating vessels may be provided. For example, incubators may be provided by providing a sealed cover. A plurality of different container or location modules may be provided in a kit of modules.

The container or location modules 16 may include a temperature changer in the form of a heating or a cooling element or elements or both (such as RS—245-685). Thus, the temperature control module may not include a temperature changer. The container or location modules may include a temperature measurement device (such as a thermocouple, thermistor or platinum resistance thermometer (PRT) sensor or other resistance thermometer). Thus, the temperature control module may not include a temperature measurement device. The device sample interface or container or location module enables samples or items to be temperature controlled using the most appropriate method.

The main controller unit or temperature control module 12 may include additional interfaces to allow connection to remote computing devices either by wired or wireless means. These interfaces may allow remote control of the temperature control module and for the transfer of measurement and performance data made during use to a remote device from a memory held in the controller unit.

The temperature control module 12 may include a magnetic stirrer for stirring liquid heat transfer medium, such as water, in the container module 16.

The main controller unit or temperature control module 12 may recognise the type or precise type of device sample interface or container module 16 being placed on it or connected to it by a coding provided on the device sample interface which is electronically read by the main controller unit. This may be achieved by, for example, applying a specific electrical resistance value, using an electrical resistor, to each type of device sample interface which may be read over the interface 14 (of FIG. 1) or, in other words, through the connection between the temperature control module connection and the location or container module connection. Alternatively, this recognition may be carried out wirelessly via the connection between the temperature control module connection and the location or container module connection.

The interface 14 (of FIG. 1), in other words, the connection between the location or container module 16 and the temperature control device 12 may be achieved via a multiway connector either custom to the role or using commercial connection systems (for example, Harting—09 14 005 2716). All connections may be made using electrically conductive connections, but could also be a mix of wire and wireless connection methods. Additional mechanical protection may be provided to avoid accidental disconnection of the main controller unit and the device sample interface during operation, for example by a mechanical interlock or, in other words, the temperature control device and location or container module may be configured to be locked together.

Embodiments of the present invention have been described. It will be appreciated that variations and modifications may be made to the described embodiments within the scope of the present invention.

1-50. (canceled)

51. A modular temperature control system for controlling temperature of at least one item in the form of a scientific sample, the modular temperature control system comprising a plurality of modules including a location module and a temperature control module:
the location module being arranged to locate at least one item in the form of a scientific sample or food sample to be cooked sous vide, and the location module comprising a location module connector for connecting to a control module connector of the temperature control module;
the temperature control module comprising a controller to control temperature of the at least one item and a control module connector for connecting to the location module connector;
the modular temperature control system being configured such that, in use, the control module connector is connected to the location module connector; and the controller of the temperature control module controls the temperature of the at least one item via the connected control module connector and location module connector.

52. A modular temperature control system according to claim 51, wherein the modular temperature control system further comprises a temperature measurement probe for measuring the temperature of the item(s).

53. A modular temperature control system according to claim 52, wherein the location module:
(a) comprises the temperature measurement probe; and/or
(b) comprises a water bath or a dry block heater or a dry block cooler or an incubator or a hot plate.

54. A modular temperature control system according to claim 52, wherein the temperature measurement probe is electrically connected to the location module connector.

55. A modular temperature control system according to claim 51, wherein the modular temperature control system further comprises a temperature changer, such as a heater or a cooler or the like.

56. A modular temperature control system according to claim 55, wherein the location module comprises the temperature changer.

57. A modular temperature control system according to claim 51, wherein the temperature control module:
(a) controls temperature of the at least one item of below ±0.3° C. of a target temperature; and/or
(b) comprises a magnetic stirrer; and/or
(c) comprises a user interface; and/or
(d) comprises a mains electricity supply and provides electrical power to the location module through the connected control module connector and location module connector.

58. A modular temperature control system according to claim 51, wherein the control module connector and location module connector are configured to be:
(a) electrically connected together; and/or
(b) wirelessly connected together.

59. A modular temperature control system according to claim 51, wherein the control module connector and location module connector are configured to be mechanically connected together.

60. A modular temperature control system according to claim 59, wherein the control module connector and the location module connector are configured to be locked together.

61. A modular temperature control system according to claim 51, wherein the controller comprises a microprocessor.

62. A modular temperature control system according to claim 61, wherein the microprocessor controls temperature of the at least one item as a proportional-integral-derivative (PID) controller.

63. A modular temperature control system according to claim 51, wherein the location module is a container module and wherein the temperature control module can recognise the type of container module being placed on it or connected to it by a coding provided on a device sample interface which can be electronically read by the controller.

64. A temperature control module for a modular temperature control system for controlling temperature of at least one item in the form of a scientific sample, the modular temperature control system comprising a plurality of modules including the temperature control module and a location module arranged to locate the at least one item:
the temperature control module comprising a controller to control temperature of at least one item and a control module connector for connecting to a location module connector of a location module; and
the temperature control module being configured such that, in use, the control module connector is connected to the location module connector of the location module;
and the controller of the temperature control module controls the temperature of the at least one item via the connected control module connector and location module connector.

65. A temperature control module according to claim 64, wherein:
(a) the temperature control module controls temperature of the at least one item of below ±0.5° C. of a target temperature; and/or
(b) the location module comprises a water bath or a dry block heater or a dry block cooler or an incubator or a hot plate; and/or
(c) the control module connector is configured to be electrically connected to the location module connector; and/or
(d) the control module connector is configured to be mechanically connected to the location module connector; and/or
(e) the control module connector is configured to lock to the location module connector; and/or
(f) the control module connector is configured to be wirelessly connected to the location module connector; and/or
(g) the temperature control module comprises a magnetic stirrer; and/or
(h) the temperature control module comprises a user interface; and/or
(i) the temperature control module comprises a mains electricity supply and provides electrical power to the location module through the control module connector.

66. A temperature control module according to claim 64, wherein the controller comprises a microprocessor.

67. A temperature control module according to claim 66, wherein the microprocessor controls temperature of the at least one item as a proportional-integral-derivative (PID) controller.

68. A location module for a modular temperature control system for controlling temperature of at least one item in the form of a scientific sample, the modular temperature control system comprising a plurality of modules including a temperature control module and the location module:
the location module being arranged to locate at least one item in the form of a scientific sample, and the location module comprising a location module connector for connecting to a control module connector of a temperature control module;
the location module being configured such that, in use, the control module connector is connected to the location module connector; and a controller of the control module controls the temperature of the at least one item via the connected control module connector and location module connector.

69. A location module according to claim 68, wherein:
(a) the location module comprises a temperature measurement probe; and/or
(b) the temperature measurement probe is electrically connected to the location module connector; and/or
(c) the location module comprises a temperature changer, such as a heater or a cooler or the like; and/or.
(d) the location module comprises a water bath or a dry block heater or a dry block cooler or an incubator or a hot plate; and/or
(e) the location module connector is configured to be electrically connected to the control module connector; and/or
(f) the location module connector is configured to be mechanically connected to the control module connector; and/or
(g) the location module connector is configured to be locked to the control module connector; and/or
(h) the location module connector is configured to be wirelessly connected to the control module connector; and/or
(i) the temperature control module can recognise a type of container module being placed on it or connected to it by a coding provided on a device sample interface which can be electronically read by the controller.

70. A method of assembling a modular temperature control system for controlling temperature of at least one item in the form of a scientific sample, the modular temperature control system comprising a plurality of modules including a location module and a temperature control module:
the location module being arranged to locate at least one item in the form of a scientific sample, and the location module comprising a location module connector for connecting to a control module connector of the temperature control module;
the temperature control module comprising a controller to control temperature of the at least one item and a control module connector for connecting to the location module connector;
the modular temperature control system being assembled by connecting the location module connector to the control module connector.

71. A method of assembling a modular temperature control system according to claim 70, wherein the connecting is by placing the location module on the temperature control module, sliding the location module on to and/or to engage with the temperature control module, or lifting the location module to engage with the temperature control module.

72. A kit of modules which, when assembled, form a temperature control system for controlling temperature of at least one item in the form of a scientific sample, the modules including a location module and a temperature control module:
the location module being arranged to locate at least one item in the form of a scientific sample, and the location module comprising a location module connector for connecting to a control module connector of the temperature control module;
the temperature control module comprising a controller to control temperature of the at least one item and a control module connector for connecting to the location module connector;
the modular temperature control system being configured such that when assembled and, in use, the control module connector is connected to the location module connector; and the controller of the temperature control module controls the temperature of the at least one item via the connected control module connector and location module connector.

73. A kit of modules according to claim 72, wherein the kit of modules comprises a plurality of different location modules.

74. A kit of modules according to claim 73, wherein the different location modules:
(a) are of different sizes or are for containing different heat transfer media; and/or
(b) comprise at least two of: a water bath, a hot plate and a solid block.
